(19) United States
(12) Patent Application Publication
(10) Pub. No.: US 2009/0139607 A1
(43) Pub. Date: Jun. 4, 2009

(54) BRAZE COMPOSITIONS AND METHODS OF USE

(75) Inventors: Lawrence Bernard Kool, Clifton Park, NY (US); Ann Melinda Ritter, Niskayuna, NY (US); David Edwin Budinger, Loveland, OH (US); Liang Jiang, Schenectady, NY (US); Laurent Cretegny, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/925,962

(22) Filed: Oct. 28, 2007

(51) Int. Cl. B23K 35/36

(52) U.S. Cl. 148/23

(57) ABSTRACT

Braze compositions containing flux compositions and processes for using such braze compositions, such as for use in the manufacturing, coating, repair, and build-up of superalloy components. The braze composition contains an aqueous binder system, multiple inorganic compounds, titanium hydride, and a metallic braze alloy. The braze composition is useful when brazing superalloys that are prone to oxidation at elevated brazing temperatures.

### BACKGROUND OF THE INVENTION

This invention generally relates to braze compositions and processes. More particularly, this invention relates to multi-compound flux compositions capable of promoting the flow of molten braze materials, such as for use in the manufacturing, coating, repair, and build-up of superalloy components.

Nickel, cobalt, and iron-base superalloys are widely used to form high temperature components of gas turbine engines. While some high-temperature superalloy components can be formed as a single casting, others are preferably or necessarily fabricated by other processes. As an example, brazing can be used to fabricate certain gas turbine components, such as high pressure turbine nozzle assemblies. Brazing is also used to repair cracks and other surface flaws and damage, build up surfaces to restore desired dimensions, and form protective coatings on gas turbine engine components. Brazing techniques of these types encompass heating a braze material, typically in the form of a braze alloy powder, a paste or tape containing a braze alloy powder, or a sintered preform of a braze alloy powder, to a temperature above the melting point of the braze alloy, but sufficiently below the melting point of the material being brazed to avoid damaging and/or reducing desired properties of the material. (As used herein, “melting point” is meant to encompass the incipient melting point for alloys that do not have a true melting point but instead have a melting range.) For example, brazing temperatures are typically limited to avoid grain growth, incipient melting, recrystallization, and/or unfavorable phase formation. In situations where a brazement must have a composition and properties similar to the substrate being brazed, the predominant constituent of the braze alloy is typically the base constituent of the substrate, and in some instances may have essentially or nearly the same composition as the substrate but modified to contain one or more melting point suppressants, such as boron and/or silicon, which form low melting eutectics with the substrate material. Notable examples of braze alloys for brazing nickel-base superalloys include AMS 4777 with a nominal composition of, by weight, about 7% chromium, about 4% silicon, about 3% boron, about 3% iron, about 0.06% carbon, the balance nickel and incidental impurities.

Effective brazing requires effective flow, coverage, and filling of a defect or braze joint. Depending on the alloy being brazed, brazing operations can be performed in a furnace or with a localized heat source, such as a torch. For alloys prone to oxidation at brazing temperatures, brazing is often performed in a furnace containing a protective atmosphere, such as a vacuum or inert gas. In very demanding applications, such as the brazing of superalloys requiring surfaces that are very clean and oxide-free, a flux composition may be used that melts or decomposes during brazing, displaces oxides such as alumina and chromia that naturally form on, respectively, aluminum and chromium-containing alloys, and promotes wetting of the cleaned surface by the molten braze alloy. Suitable flux compounds must have a melting temperature lower than that of the braze alloy used, such that the flux is able to displace the oxides prior to melting and flowing of the braze alloy. Examples of brazing flux compounds include potassium fluoride, cesium fluoride, lithium fluoride, and aluminum fluoride as fluoroaluminum complexes. Particular examples include potassium fluoroaluminate complexes such as potassium tetrafluoroaluminate (KAlF₄), potassium fluoroborate complexes such as potassium tetrafluoroborate (KBF₄), and cesium fluoroaluminate complexes such as cesium tetrafluoroaluminate (CsAlF₄). These flux compounds can be dissolved in an aqueous solution, which can then be combined with a powder of the desired braze alloy to form a braze paste. After its application to the surface being repaired, the braze paste is dried to evaporate the water, leaving only a mixture of the braze alloy powder and flux solids on the surface to be brazed. Brazing is then typically performed by heating in an inert furnace atmosphere, upon which the flux solids melt and displace oxides on the surface, followed soon after by melting and flowing of the braze alloy.

When brazing certain alloys particularly susceptible to oxidation at brazing temperatures, additional measures may be necessary. For example, when brazing Inconel 718 (IN 718) with AMS 4777, it can be necessary to plate the surface to be brazed with nickel to prevent oxidation during heating to braze temperatures, even if the brazing operation is performed in a vacuum furnace. As an alternative, braze alloys exist that are able to wet and braze alloys such as IN 718 without the additional expense of nickel plating and fluxes. An example is M³ 85, whose nominal composition is, by weight, about 30.5% palladium, about 10.5% chromium, about 2.45% boron, the balance nickel and incidental impurities. However, M³ 85 has a cost disadvantage due to its high palladium content. Consequently, there is an ongoing need for advancements in brazing compositions and processes, particularly those suitable for use when brazing alloys susceptible to oxidation during brazing.

### BRIEF SUMMARY OF THE INVENTION

The present invention generally provides braze compositions containing multiple flux compounds, and processes for making and using such braze compositions, such as for use in the manufacturing, repair, build-up, and coating of superalloy components. More particularly, the invention provides and makes use of flux compounds and titanium hydride (TiH₂) that, in combination, enable the flux composition to melt and/or decompose over a range of temperatures, thereby promoting the flow of a molten braze alloy during brazing.

According to one aspect of the invention, a braze composition is provided that comprises an aqueous binder system, a flux composition containing multiple inorganic compounds, and titanium hydride. The multiple inorganic compounds include potassium tetrafluoroaluminate and/or potassium tetrafluoroborate, more preferably both. The flux composition may contain additional inorganic compounds that, while optional, if used can be preferably selected to have a decomposition temperature or to form an intermediate complex having a decomposition temperature that is above or below the decomposition temperatures of potassium tetrafluoroaluminate and potassium tetrafluoroborate. According to a preferred aspect of the invention, the braze composition further contains a metallic braze alloy and is in the form of a braze paste or slurry suitable for use in manufacturing, coating, repair, and build-up of superalloy components.

According to another aspect of the invention, a braze process is provided for preparing and using a braze composition. The process generally entails combining titanium hydride, a flux composition containing multiple inorganic compounds, and an aqueous binder system. The multiple inorganic compounds include potassium tetrafluoroaluminate and/or potassium tetrafluoroborate, preferably both, and may include additional inorganic compounds or precursors thereof that may have, or may form intermediate complex compounds that may have, decomposition temperatures above or below the decomposition temperatures of potassium tetrafluoroaluminate and potassium tetrafluoroborate.

Combinations of titanium hydride and flux compositions as described above have been found to be capable of promoting the wetting and brazing by braze alloys such as the AMS4777 of superalloys such as IN 718 without resorting to nickel plating to prevent oxidation during heating to braze temperatures. While not wishing to be held to any particular theory, braze alloy flow is believed to be promoted as a result of titanium hydride synergistically cooperating and, when dissolved in the aqueous binder system, chemically reacting with potassium tetrafluoroaluminate and/or potassium tetrafluoroborate, possibly to form one or more beneficial intermediate complex fluoride compounds. Improved braze flow is also believed to be attributable to the intermediate complex fluoride compounds broadening the temperature range over which the flux composition melts and/or decomposes, and particularly beyond the melting/decomposition temperatures of potassium tetrafluoroaluminate (about 700° C.) and potassium tetrafluoroborate (about 300° C.).

In view of the above, the present invention is believed to be particularly advantageous for use in joining superalloy components, including those found in the hot gas path of gas turbine engines, and especially those components that tend to oxidize at brazing temperatures. Other potential uses include crack-filling (repairing) and coating of such superalloy components.

Other objects and advantages of this invention will be better appreciated from the following detailed description.

### BRIEF DESCRIPTION OF THE DRAWINGS

FIG. 1 schematically represents a braze composition applied between two to substrates to be joined, and

FIG. 2 schematically represents the resulting joined substrates of FIG. 1 following a brazing cycle.

FIG. 3 schematically represents a braze composition applied to a surface in which a crack is present and to be repaired, and

FIG. 4 schematically represents the repaired crack of FIG. 3 following a brazing cycle.

FIGS. 5 and 6 contain Tables I and II, respectively, which identify two groups of braze compositions evaluated in investigations leading to the present invention.

### DETAILED DESCRIPTION OF THE INVENTION

The invention will be described with reference to processing of superalloy components for gas turbine engines, and particularly the joining and repair of such components with a braze material. However, the invention has application to a variety of components, materials, and processes other than those discussed, and such variations are within the scope of this invention. It should be further noted that the drawings are drawn for purposes of clarity when viewed in combination with the following description, and therefore are not necessarily to scale.

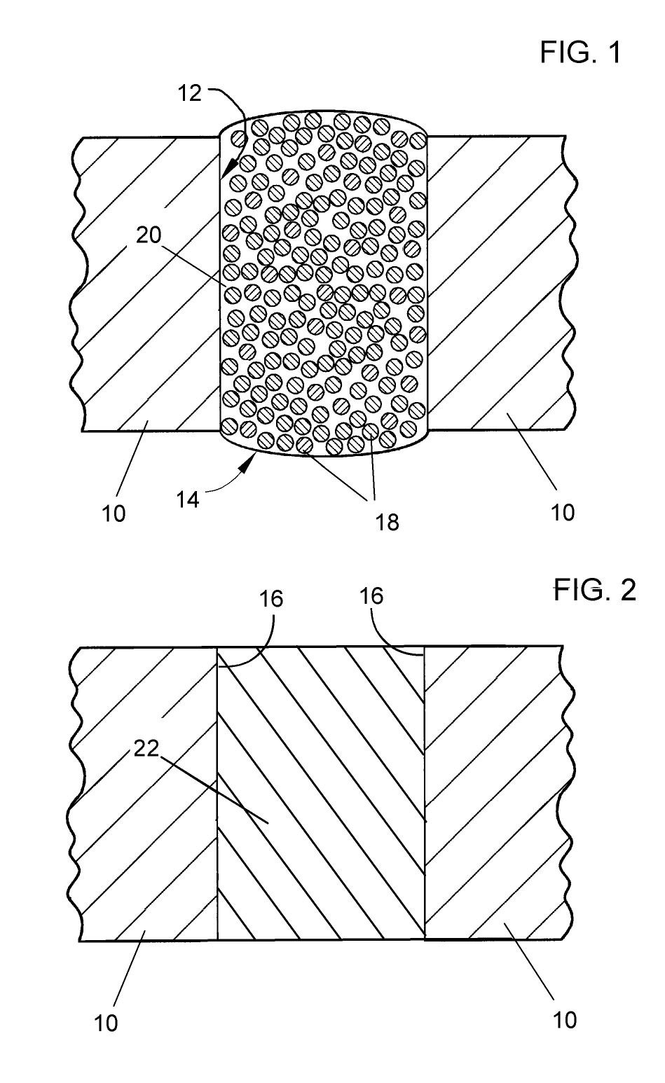

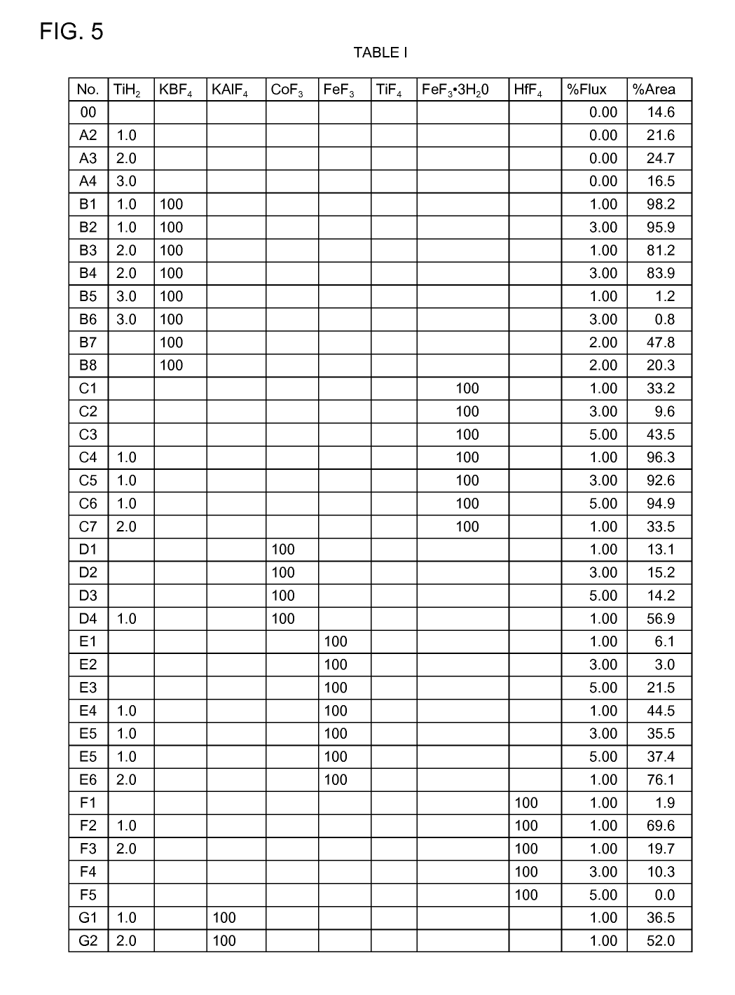

FIGS. 1 through 4 depict embodiments of this invention in which consistent reference numbers are used to identify functionally similar structures. FIG. 1 schematically represents a braze composition 14 of this invention within a gap 12 between opposing surface 16 of two substrates 10 to be metallurgical joined by the braze composition 14, while FIG. 3 schematically represents the braze composition 14 deposited on a crack 12 within a surface 16 of a substrate 10. The substrates 10 may be part of a gas turbine engine component, and therefore may be formed of a superalloy or another material suitable for the particular type of component and its anticipated operating conditions. The gap 12 and crack 12 may be very narrow, necessitating that the braze composition 14 readily wet and flow into the gap/crack 12 by capillary action.

In both FIGS. 1 and 3, the braze compositions 14 are represented as containing braze alloy particles 18 in a matrix 20, which together preferably constitute a paste. The particles 18 have a preferred size range of about 45 to about 105 micrometers to promote rapid melting, though it is foreseeable that larger or smaller particles could be employed, depending on the type of repair to be made. The braze alloy particles 18 can be formed of various metallic and nonmetallic materials for compatibility with the substrates 10. Particularly suitable compositions for the alloy particles 18 will depend in part on the particular composition of the alloy being repaired, which in the case of gas turbine engine components will typically be a nickel-base or cobalt-base superalloy. As known in the art, the braze alloy for the particles 18 must also be chosen on the basis of being capable of readily wetting and metallurgically bonding to the substrates 10, and having a melting temperature that is sufficiently high to promote the high temperature properties of the resulting joint or repair, though less than the grain growth or incipient melting temperature of the superalloy in order to preserve the microstructure of the component during the repair process. Notable examples of suitable braze alloys include the aforementioned AMS 4777 and M³ 85, which are both metallurgically compatible with nickel-based superalloys and have melting temperatures of about 1825° F. (about 996° C.) and about 1790° F. (about 977° C.), respectively, which are less than temperatures at which many superalloys such as IN 718 will exhibit grain growth or incipient melting. Various other braze alloys are known to have the above characteristics, and therefore the invention is not to be limited to the use of any particular braze alloy.

According to a preferred aspect of the invention, the matrix 20 is made up of a flux composition containing multiple inorganic compounds. The flux composition is held in a binder, preferably a water-based binder that burns off cleanly during the brazing process, which is preferably performed in an inert or low pressure atmosphere to minimize oxidation of the particles 18 and the surfaces 16 of the substrates 10 on which the particles 18 melt and become metallurgically bonded. According to this invention, two of the multiple inorganic compounds used to form the matrix 20 of the braze composition 14 are preferably potassium tetrafluoroaluminate (KAlF₄) and potassium tetrafluoroborate (KBF₄). The matrix 20 may further contain optional inorganic compounds, particularly fluoride compounds, which may be capable of reacting when dissolved in the binder to form intermediate complex fluoride compounds. At least some of the optional inorganic compounds and/or intermediate complex fluoride compounds thereof preferably have melting and/or decomposition temperatures that differ from potassium tetrafluoroaluminate and potassium tetrafluoroborate, and more preferably are either above or below the decomposition temperatures of potassium tetrafluoroaluminate and potassium tetrafluoroborate such that thermal decomposition of the flux composition within the matrix 20 will occur over a broader temperature range than that provided by the combination of potassium tetrafluoroaluminate and potassium tetrafluoroborate alone, whose decomposition temperatures are about 700° C. and about 300° C., respectively. Preferred optional inorganic compounds are fluoride compounds such as titanium tetrafluoride (TiF₄), cobalt trifluoride (CoF₃), ferric fluoride (FeF₃; anhydrous), ferric fluoride trihydrate (FeF₃.3H₂O), hafnium tetrafluoride (HfF₄), and palladium difluoride (PdF₂).

Particularly preferred flux compositions for use with this invention contain up to about 25 weight percent of one or more of the optional inorganic compounds identified above, with the balance preferably potassium tetrafluoroaluminate and potassium tetrafluoroborate. If present, the combined optional inorganic compounds constitute up to about 15 weight percent (for example, about 5 to about 15 weight percent), more preferably up to about 12.5 weight percent (for example, about 10 to about 12.5 weight percent), of the flux composition. Potassium tetrafluoroaluminate and potassium tetrafluoroborate constitute the balance of the flux composition in the matrix 20. The ratio of potassium tetrafluoroaluminate to potassium tetrafluoroborate is about 20:90 to about 50:50, more preferably about 20:80 to about 30:70. The flux composition may constitute up to about 5 weight percent of the braze composition 14, more preferably about 0.5 to about 3.0 weight percent of the braze composition 14, and most preferably about 1.0 to about 2.0 weight percent of the braze composition 14.

Another component of the matrix 20 is titanium hydride (TiH₂), the role of which is not entirely understood. While not wishing to be held to any particular theories, it is speculated that titanium hydride reacts in the presence of inorganic fluoride compounds and water (present as a result of the water-based binder) at elevated temperatures, possibly reacting with potassium tetrafluoroaluminate and/or potassium tetrafluoroborate to form titanium tetrafluoride and/or hydrogen fluoride, and that such a reaction promotes the cracking and displacement of oxides, including alumina and chromia that form on aluminum and chromium-containing alloys, to promote the brazeability of the substrates 10. Braze compositions for use with this invention may contain up to about 5 weight percent titanium hydride. Titanium hydride more preferably constitutes about 0.25 to about 2 weight percent, more preferably about 0.5 to about 1.25 weight percent, of the combined weight of the braze composition 14.

Aside from the flux composition and titanium hydride, the braze alloy particles 18 and the binder preferably constitute the remaining constituents of the braze composition 14. The braze alloy particles 18 generally constitutes at least about 80 weight percent and up to about 90 weight percent of the braze composition 14, with a particularly suitable range believed to be about 84 to about 86 weight percent, with optimal levels being dependent in part on the particular composition of the particles 18. As noted above, preferred binders are water-based binders. Suitable binders of this type are believed to include VITTA GEL®, commercially available from the Vitta Corporation. As previously noted, the binder provides a medium in which the multiple inorganic compounds of the flux composition dissolve, and in which titanium hydride can react with potassium tetrafluoroaluminate and/or potassium tetrafluoroborate to form titanium tetrafluoride and/or hydrogen fluoride. The amount of binder used in the braze composition will generally determine its consistency. For paste-like consistencies, the binder generally constitutes at least about 10 weight percent and up to about 17 weight percent of the braze composition 14, with a particularly suitable range believed to be about 12 to about 15 weight percent.

The braze composition 14 is preferably used in the form of a paste, though the braze composition 14 could also be used in the form of a slurry, putty, presintered preform, or polymeric tape. In the preferred form, the braze composition 14 is applied as a paste that can be readily and precisely applied to the gap/crack 12 and remain adhered to the surface(s) 16 of the substrate(s) 10 throughout the brazing operation.

After the braze composition 14 is applied to the component surfaces 16 as represented in FIGS. 1 and 3, the substrate 10 or substrates 10 are heated to a temperature sufficient to evaporate the water of the binder, and subsequently burn off the binder, followed by melting or decomposition of the flux composition and then melting of the braze alloy particles 18. This treatment may be performed within a vacuum or inert atmosphere, with appropriate hold temperatures being used as may be desired or necessary. Suitable hold temperatures, including the braze temperature, will depend on the particular compositions of the braze alloy particles 18 and the inorganic compounds of the flux composition. When using the preferred inorganic compounds in the amounts described above, the flux composition will melt over a temperature range, generally about 200° C. to about 1000° C., and therefore broader than the melting/decomposition range of about 300° C. to about 700° C. that would exist if only potassium tetrafluoroaluminate and potassium tetrafluoroborate were used in the braze composition 14.

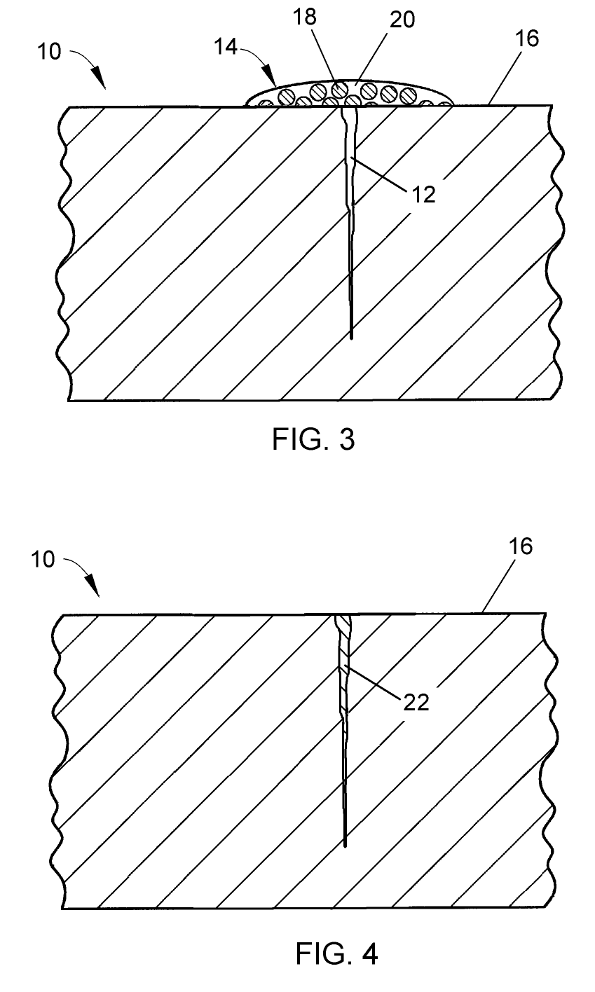

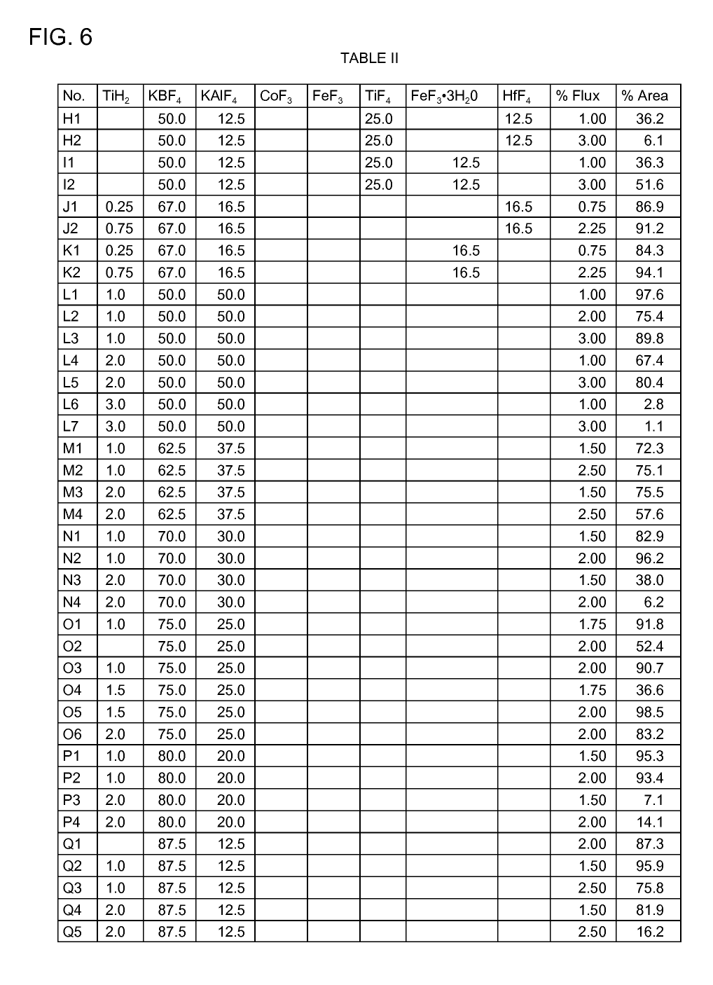

Following the braze cycle, the repaired component preferably undergoes heat treatment to further interdiffuse the braze alloy and the superalloy. After heat treatment, any excess braze alloy can be removed by conventional grinding methods. FIGS. 2 and 4 schematically depict the appearance of a resulting joint 22 and repaired crack 22, respectively.

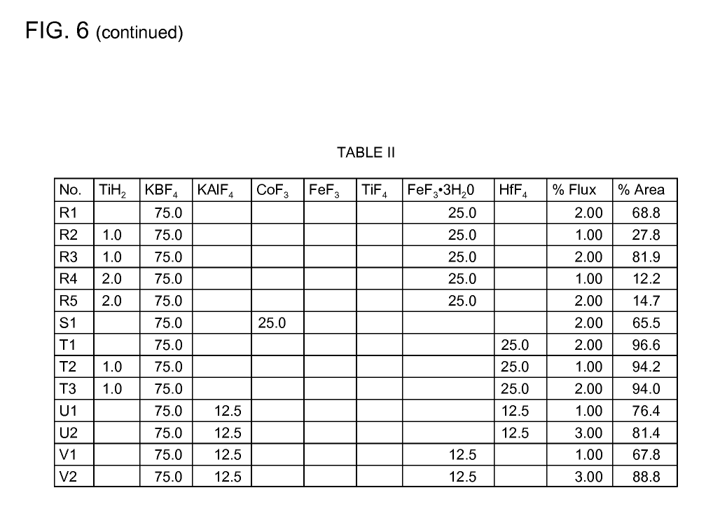

The braze composition 14 of this invention has been successfully evaluated on specimens formed of IN 718 and brazed to assess the performance of titanium hydride and various inorganic flux compounds, both individually and in combination. The braze alloy powder used was the aforementioned AMS 4777. The braze alloy, titanium hydride (if present), and selected flux compounds (if present) were mixed to form braze compositions that were applied directly on one side of a one-half inch (about 13 mm) minimum overlap specimen. Table I in FIG. 5 identifies a first group of braze compositions evaluated by brazing in a vacuum furnace at 1885° F.+/−about 15° F. (about 1030° C.+/−about 8° C.) for about five minutes. X-ray and image analysis techniques were then used to determine the braze coverage percentage within the overlap (“% Area”). In Table I, “TiH₂” indicates the titanium hydride content in the braze composition, and “KBF₄,” “KAlF₄,” CoF₃,” “FeF₃,” “TiF₄,” “FeF₃.3H₂O,” and “HfF₄” indicate the respective contents in weight percent of these individual flux compounds in the mixture of flux compounds that formed the flux composition of the braze composition. An empty cell in Table I indicates the absence of that constituent in the braze composition. “% Flux” indicates in weight percent the flux composition content in the braze composition, and “% Area” quantitatively describes the resulting brazements. In Table I, a flux-free, TiH₂-free specimen (i.e., containing only the braze alloy powder) was processed to establish a baseline (No. 00). For the remaining specimens reported in Table I, the braze compositions contained the braze alloy combined with TiH₂ only, or combined with a single flux compound only, or combined with TiH₂ and a single flux compound. For those specimens containing a flux compound, the flux compound is reported as constituting 100% of the flux composition (i.e., the flux composition is not a mixture of multiple flux compounds).

As evident from the “% Area” values in Table I, braze compositions containing the braze alloy and only TiH₂ (A1 through A4) produced a relatively low improvement in internal braze coverage over the baseline braze composition No. 00, as did compositions containing the braze alloy and the individual flux compounds (B7, B8, C1-C3, D1-D3, E1-E3, F1, F4, and F5). Combinations of TiH₂ and the individual flux compounds exhibited the greatest improvement, especially if the flux compound was KBF₄ (B1-B4) and FeF₃.3H₂0(C4-C6). Replication of the most promising combinations of TiH₂+flux compounds demonstrated that mixtures of KBF₄ and TiH₂ yielded the most consistent results.

Table II in FIG. 6 identifies a second group of experiments that evaluated flux compositions containing mixtures of KBF₄ and one or more of the flux compounds from the previous experiment, with and without TiH₂). The experiments were conducted with specimens formed of IN 718 and used AMS 4777 as the braze alloy. The braze alloy and selected inorganic flux compounds were mixed and then applied directly to one side of a two-inch (about 50 mm) specimen, which was then overlapped with a second specimen to achieve a overlap length of about 0.5 to one inch (about 13 to about 25 mm). The specimens were brazed under the same conditions as the previous investigation, after which evaluations were conducted by x-ray examinations along with image analysis to determine percent internal area coverage (“% Area”). In Table II, “TiH₂” indicates the titanium hydride content in the braze composition, and “KBF₄,” “KAlF₄,” CoF₃,” “FeF₃,” “TiF₄,” “FeF₃.3H₂0,” and “HfF₄” indicate the respective contents in weight percent of these individual flux compounds in the mixture of flux compounds that formed the flux composition of the braze composition. An empty cell in Table II indicates the absence of that constituent in the braze composition. “% Flux” indicates in weight percent the flux composition content in the braze composition, and “% Area” quantitatively describes the resulting brazements.

As expected, the braze compositions containing combinations of flux compounds exhibited flux decomposition or melting over a range of temperatures. As evident from the “% Area” values in Table II, braze compositions containing a combination of fluxes also exhibited benefits when combined with TiH₂. Combinations of KFB₄ and KAlF₄ and combinations of KFB₄ and HfF₄ exhibited the best internal coverage (% area). Variations in the ratio of KFB₄ to KAlF₄, combined weight percent of KFB₄ and KAlF₄ in the braze composition, and weight percent TiH₂ in the braze composition were evaluated to determine the optimized process window. From these results, it appeared that the TiH₂ content should be less than 3.0 weight percent of the braze composition, and preferably less than 2.0 weight percent in braze compositions containing more KFB₄ than KAlF₄, with increasing lower amounts of TiH₂ appearing to be beneficial with increasing KFB₄:KAlF₄ ratios. It was also concluded that, when KFB₄+KAlF₄ is used as the flux composition, the flux composition content is preferably about 1 to about 2 weight percent of the braze composition.

While the invention has been described in terms of particular embodiments, it is apparent that other forms could be adopted by one skilled in the art. Accordingly, the scope of the invention is to be limited only by the following claims.

1. A braze composition comprising an aqueous binder system, titanium hydride, and a flux composition containing multiple inorganic compounds comprising potassium tetrafluoroaluminate and potassium tetrafluoroborate.

2. The braze composition according to claim 1, wherein the multiple inorganic compounds further comprise at least one additional inorganic compound having a decomposition temperature that is above or below the decomposition temperatures of potassium tetrafluoroaluminate and potassium tetrafluoroborate.

3. The braze composition according to claim 2, wherein the at least one additional inorganic compound is selected from the group consisting of titanium tetrafluoride, palladium fluoride, cobalt trifluoride, titanium hydride, ferric fluoride, ferric fluoride trihydrate, and hafnium tetrafluoride.

4. The braze composition according to claim 1, wherein potassium tetrafluoroaluminate and potassium tetrafluoroborate are present in the flux composition at a weight ratio of about 20:80 to about 50:50.

5. The braze composition according to claim 1, wherein the braze composition consists of the aqueous binder system, the flux composition, titanium hydride, and a metallic braze alloy.

6. The braze composition according to claim 5, wherein the multiple inorganic compounds comprise at least one selected from the group consisting of titanium tetrafluoride, palladium fluoride, cobalt trifluoride, titanium hydride, ferric fluoride, ferric fluoride trihydrate, and hafnium tetrafluoride.

7. The braze composition according to claim 1, wherein the braze composition further comprises a metallic braze alloy.

8. The braze composition according to claim 7, wherein titanium hydride constitutes up to about five weight percent of the braze composition.

9. The braze composition according to claim 7, wherein the flux composition constitutes up to about five weight percent of the braze composition.

10. The braze composition according to claim 7, wherein the metallic braze alloy has a nominal composition of, by weight, about 7% chromium, about 4% silicon, about 3% boron, about 3% iron, about 0.06% carbon, and the balance nickel and incidental impurities.

11. A braze composition consisting essentially of a metallic braze alloy, titanium hydride, a flux composition, and an aqueous binder system, the flux composition consisting of potassium tetrafluoroaluminate, potassium tetrafluoroborate, and optionally one or more additional inorganic compounds selected from the group consisting of titanium tetrafluoride, palladium fluoride, cobalt trifluoride, titanium hydride, ferric fluoride, ferric fluoride trihydrate, and hafnium tetrafluoride.

12. The braze composition according to claim 11, wherein titanium hydride constitutes about 0.25 to about 2 weight percent of the braze composition, and the flux composition constitutes about 0.5 to about 3 weight percent of the braze composition.

13. A brazing process comprising preparing a braze composition by combining titanium hydride, a flux composition containing multiple inorganic compounds, and an aqueous binder system, the multiple inorganic compounds comprising potassium tetrafluoroaluminate and potassium tetrafluoroborate.

14. The brazing process according to claim 13, wherein the multiple inorganic compounds comprise at least one inorganic compound having a decomposition temperature that is above or below the decomposition temperatures of potassium tetrafluoroaluminate and potassium tetrafluoroborate.

15. The brazing process according to claim 14, wherein the at least one additional inorganic compound is selected from the group consisting of titanium tetrafluoride, palladium fluoride, cobalt trifluoride, titanium hydride, ferric fluoride, ferric fluoride trihydrate, and hafnium tetrafluoride.

16. The brazing process according to claim 13, wherein potassium tetrafluoroaluminate and potassium tetrafluoroborate are present in the flux composition at a weight ratio of about 20:80 to about 50:50.

17. The brazing process according to claim 13, wherein the flux composition consists of the multiple inorganic compounds.

18. The brazing process according to claim 13, further comprising the step of admixing a metallic braze alloy with the titanium hydride, the flux composition, and the aqueous binder system to form the braze composition.

19. The brazing process according to claim 18, wherein titanium hydride constitutes up to about five weight percent of the braze composition, and the flux composition constitutes up to about five weight percent of the braze composition.

20. The brazing process according to claim 18, further comprising:
applying the braze composition to at least one nickel-base superalloy substrate containing at least one of chromium and aluminum; and
heating the substrate to decompose the flux composition and melt the braze alloy.
